(19) United States
(12) Patent Application Publication
(10) Pub. No.: US 2015/0350474 A1
(43) Pub. Date: Dec. 3, 2015

(54) INTELLIGENT IMAGE REPRODUCING APPARATUS AND METHOD FOR REPRODUCING IMAGE

(71) Applicant: AVISION INC., Hsinchu (TW)

(72) Inventors: Thomas Sheng, Hsinchu (TW); Ching-Ching Lin, Hsinchu County (TW)

(21) Appl. No.: 14/341,855

(22) Filed: Jul. 28, 2014

(30) Foreign Application Priority Data
May 29, 2014 (TW) 103118753

(51) Int. Cl. H04N 1/00; H04N 1/203

(52) U.S. Cl. CPC H04N 1/00588; H04N 1/00411; H04N 1/00442; H04N 1/00689; H04N 1/00694; H04N 1/00803; H04N 1/00824; H04N 1/2034; H04N 2201/0082

(57) ABSTRACT

An intelligent image reproducing apparatus, which comprises an automatic document feeder, two image capture modules, and a controller, is disclosed. The automatic document feeder comprises a document sensor for sensing a document. The image capture modules are disposed opposite each other for scanning a front side image and a backside image of each single sheet of the document. The controller is connected electrically to the automatic document feeder, two image capture modules, and the document sensor. When the document sensor senses the document, the automatic document feeder automatically feeds a first sheet of the document, and the two image capture modules capture the front side image and the backside image of the first sheet automatically. In addition, an intelligent image reproducing method operated by electronic system for a digital processing machine is also disclosed.

### BACKGROUND OF THE INVENTION

1. Field of the Invention

The invention relates to an intelligent image reproducing apparatus and method for reproducing image, and more particularly, to an intelligent image reproducing apparatus and method for reproducing image capable of automatically performing the reproduction procedure.

2. Description of the Prior Art

Conventional image reproducing apparatuses such as digital processing machines with functions of scanning, printing, copying, and faxing have made it complicated in the process of reproducing images. For example, when a user wants to just get a copy of a physical document, he/she needs to place the document on the machine, press once the start button and select scan/copy function, confirm the image if it can be previewed, choose one-sided or two-sided output and decide whether to put the two side images at both sides of a same printed sheet or at separate sheets, and he/she even has to pay attention to the insertion direction of the physical document in order not to get unwanted result. Most of the procedures during reproducing images in these apparatuses are currently far from automation and intelligence. It almost takes the user every step to give the direction to finish the work. User-friendliness is not the case for these apparatuses. Inconvenience is closely tight to such simple requirement of reproducing images since the user has difficulty getting a reproducing image in an unconstrained and easy way.

### SUMMARY OF THE INVENTION

To solve the above problem, one of the objectives of the invention is to provide a ‘Drop & Take’ operation method so that a user may just drop a single sheet of document to be reproduced and take the reproduced document immediately without any further operation.

Another objective of the invention is to provide an automatic and intelligent image reproducing apparatus that can determine and perform automatically most of the necessary steps to provide a user friendly, effort free, and time saving features for the image reproducing apparatus.

To achieve the above objectives, the invention provides an intelligent image reproducing apparatus, including an automatic document feeder, two image capture modules, and a controller. The automatic document feeder includes a document sensor for sensing a document. The two image capture modules are disposed opposite each other for scanning a front side image and a backside image of each single sheet of the document. The controller is connected electrically to the automatic document feeder, the image capture modules, and the document sensor. When the document sensor senses the document, the automatic document feeder automatically feeds a first sheet of the document, and the image capture modules capture the front side image and the backside image of the first sheet automatically.

To achieve the above objectives, the invention also provides an intelligent image reproducing method operated by electronic system for a digital processing machine. The method includes following steps: automatically sensing a document on an automatic document feeder, automatically feeding a first sheet of the document, and automatically capturing a front side image and a backside image of the first sheet.

The advantages and spirits of the invention may be further acknowledged via the embodiments and drawings in the following description.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram of an intelligent image reproducing apparatus according to a first embodiment of the invention.

FIG. 1B is a schematic diagram of the image capture modules capturing images of a first sheet.

FIG. 1C is a schematic diagram of a flow chart of an intelligent image reproducing method performed by an electronic system according to the embodiment.

FIG. 2A is a schematic diagram of an intelligent image reproducing apparatus according to a second embodiment of the invention.

FIG. 2B is a schematic diagram of a flow chart of an intelligent image reproducing method according to the second embodiment of the embodiment.

FIG. 3A is a schematic diagram of an intelligent image reproducing apparatus according to a third embodiment of the invention.

FIG. 3B is a schematic diagram of a flow chart of an intelligent image reproducing method according to the third embodiment of the embodiment.

FIG. 4A is a schematic diagram of an intelligent image reproducing apparatus according to a fourth embodiment of the invention.

FIG. 4B is a schematic diagram of a flow chart of an intelligent image reproducing method according to the fourth embodiment of the embodiment.

### DETAILED DESCRIPTION

Embodiments are provided in the following paragraphs for detailed description, which are for exemplary purpose and should not be used as limitation of the scope of the invention. It should be noted that the term ‘document’ in the invention stands for a physical medium containing paper, name card, slide, or hard card that can be used to record text, image, form, or any type of information. For convenience, the following paragraphs use ‘sheet’, ‘paper’, ‘single sheet’, ‘plural sheets’, ‘page’, terms commonly used for describing paper, to describe the embodiments of the invention. However, any other types of medium should be applicable, too.

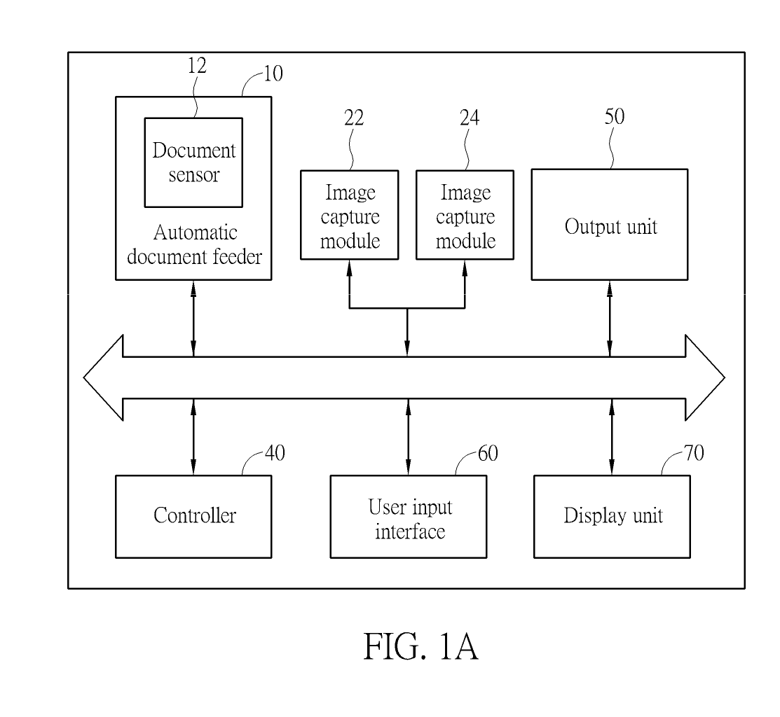

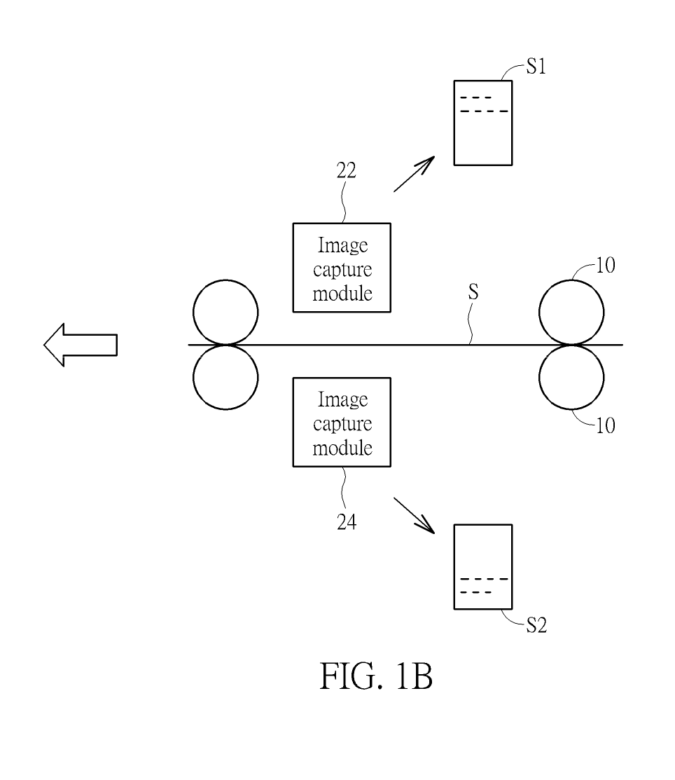

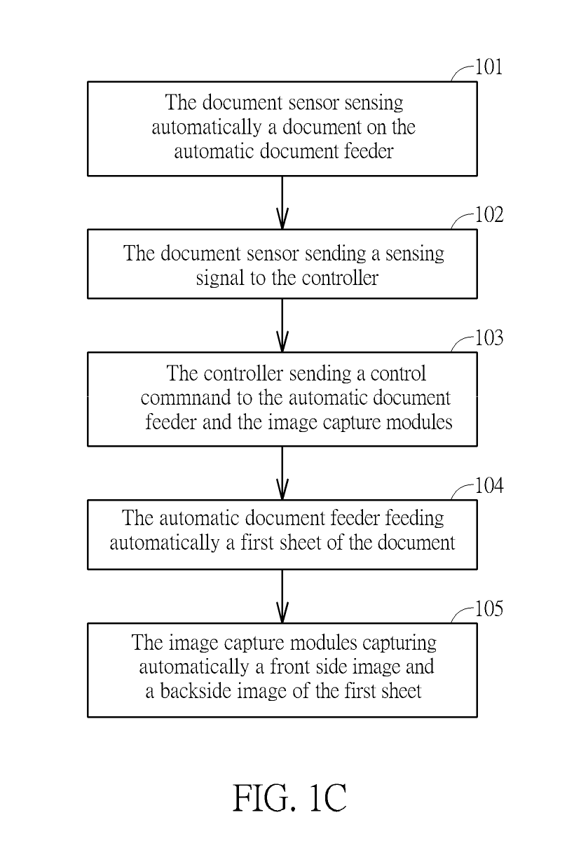

FIG. 1A is a schematic diagram of an intelligent image reproducing apparatus according to a first embodiment of the invention. Please refer to FIG. 1A. A digital processing machine 100 is an intelligent image reproducing apparatus including an automatic document feeder 10, two image capture modules 22, 24, a controller 40, an output unit 50, a user input interface 60, and a display unit 70. The automatic document feeder 10 includes a document sensor 12 for sensing a document placed thereon. The image capture modules 22, 24 are disposed opposite each other for scanning a front side image and a backside image of each sheet of a document. The document can be either a plurality of sheets including a first sheet S or a single sheet as the first sheet S. The output unit 50 is connected electrically to the controller 40 for receiving and outputting images of the document. The output unit 50 may include at least one of the following: a printer, an external storage device transmission port or a network transmission port. The user input interface 60 is adapted for receiving a command inputted by the user to determine the way of processing and outputting an image. The display unit 70 is utilized for receiving and displaying the images of the document and can be integrated with the user input interface 60 as a touch panel. The display unit 70 and the user input interface 60 can also be separate devices such as a display and a mouse. The controller 40 is connected electrically to the auto document feeder 10, the document sensor 12, the image capture modules 22, 24, the output unit 50, the user input interface 60, and the display unit 70. In other words, the controller 40 is the operational and processing core of the digital processing machine 100. Generally, the controller 40 is internally disposed in the digital processing machine 100 but can also be configured as an operational core (such as a CPU) of a remote host (such as a computer) connected electrically to the digital processing machine 100.

FIG. 1B is a schematic diagram of the image capture modules capturing images of a first sheet. Please refer to FIG. 1B. The automatic document feeder 10, a feeding roller for example, feeds the first sheet S through between the image capture modules 22, 24 with the direction of arrow standing for the moving direction of the first sheet S. The image capture modules 22, 24 capture the front side and the backside of the first sheet S for one time and generate respectively a front side image S1 and a backside image S2.

FIG. 1C is a schematic diagram of a flow chart of an intelligent image reproducing method performed by an electronic system according to the embodiment. As shown in FIG. 1C, in Step 101, the document sensor 12 senses automatically the document on the automatic document feeder 10. In Step 102, the document sensor 12 sends a sensing signal to the controller 40. In Step 103, the controller 40 sends a control command to the automatic document feeder 10 and the image capture modules 22, 24. In Step 104, the automatic document feeder 10 feeds automatically a first sheet S of the document. In Step 105, the image capture modules 22, 24 capture automatically the front side image S1 and the backside image S2 of the first sheet S.

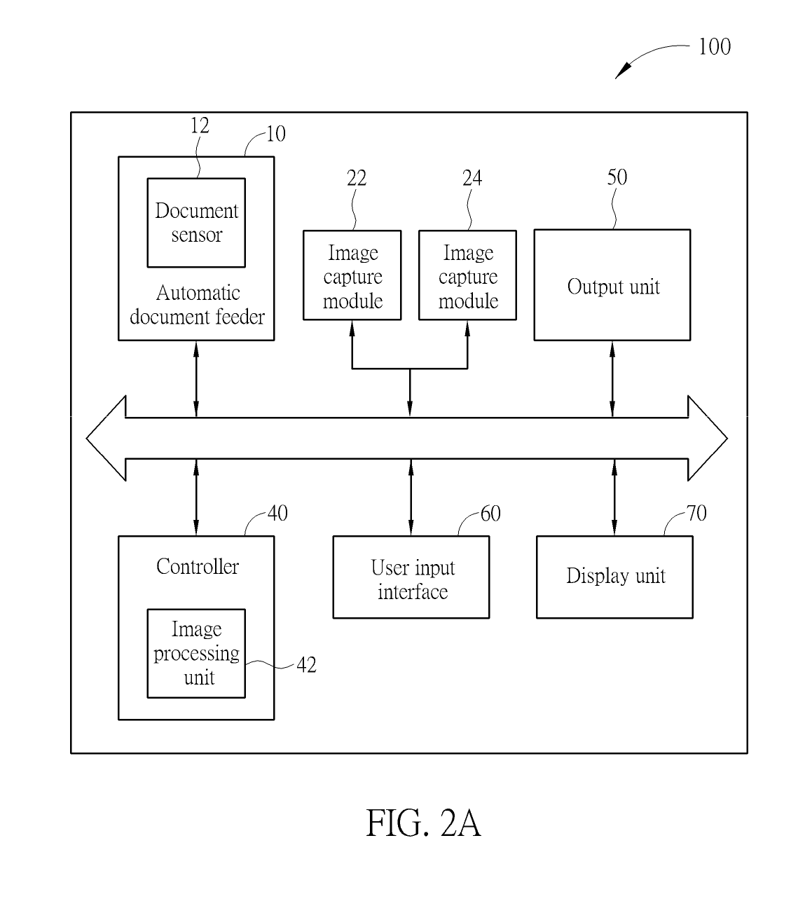

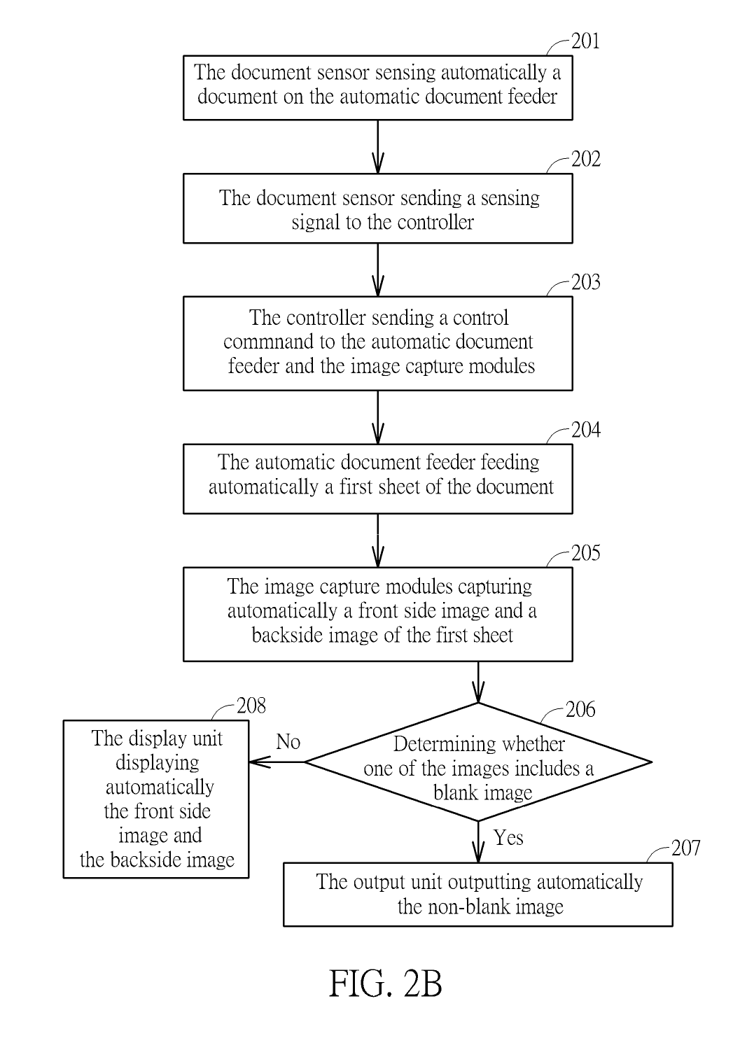

FIG. 2A is a schematic diagram of an intelligent image reproducing apparatus according to a second embodiment of the invention. Please refer to FIG. 2A. The controller 40 may further include an image processing unit 42 for determining whether the front side image S1 or the backside image S2 is blank. The image processing unit 42 may also perform deskewing, cropping, optical character recognition to the images. FIG. 2B is a schematic diagram of a flow chart of an intelligent image reproducing method according to the second embodiment of the embodiment. In FIG. 2B, Step 201 to Step 205 are the same as Step 101 to Step 105 in FIG. 1C. In Step 206, the image processing unit 42 determines whether one of the front side image S1 and the backside image S2 is a blank image and the other is a non-blank image; if yes, perform Step 207 that the controller 40 controls the output unit 50 to output automatically the non-blank image. The user needs not worry about how to place the non-blank side to be scanned since the image capture modules 22, 24 capture the front side image S1 and the backside image S2 of the first sheet S for one time and the image processing unit 42 then makes the determination. As the image processing unit 42 determines one of the front side image S1 and the backside image S2 is a blank image and the other is a non-blank image that has text or patterns, the output unit 50 will output automatically just the non-blank image having text or patterns, while the blank image will be deleted by the controller 40. The output unit 50 can be a USB connecting port, a printer, a fax module, or a network transmission port, which is capable of outputting electronic files, printed documents, fax, or emails.

On the other hand, when the image processing unit 42 determines both of the front side image S1 and the backside image S2 of the first sheet S are non-blank images, in Step 208, the controller 40 controls the display unit 70 to display automatically the front side image S1 and the backside image S2 of the first sheet S for follow-up processing determination by a user using the user input interface 60.

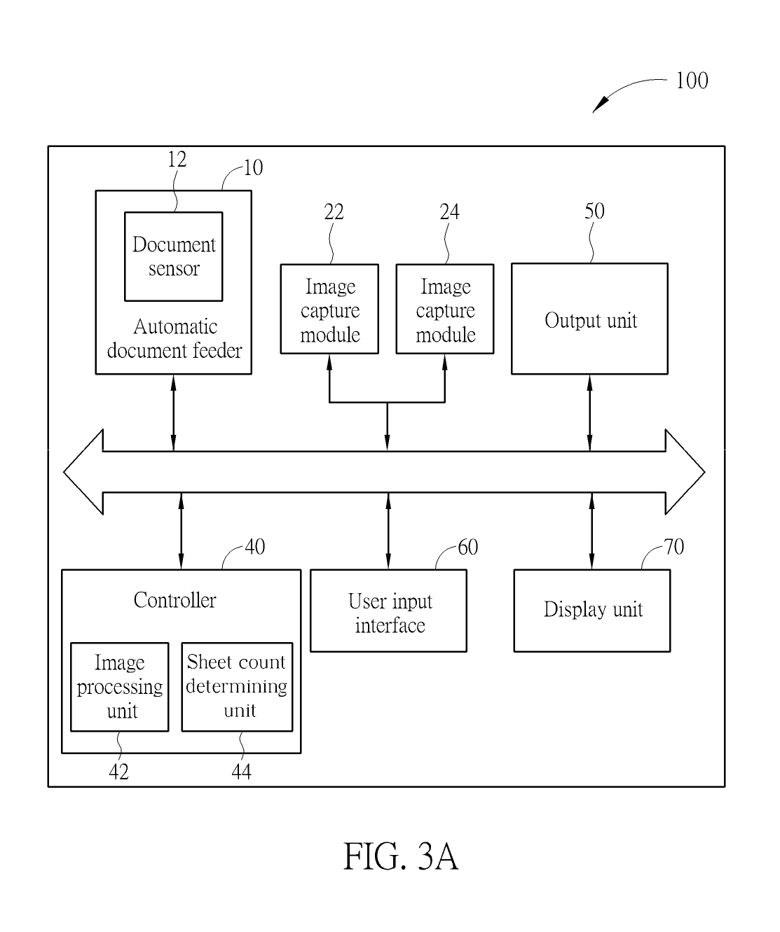

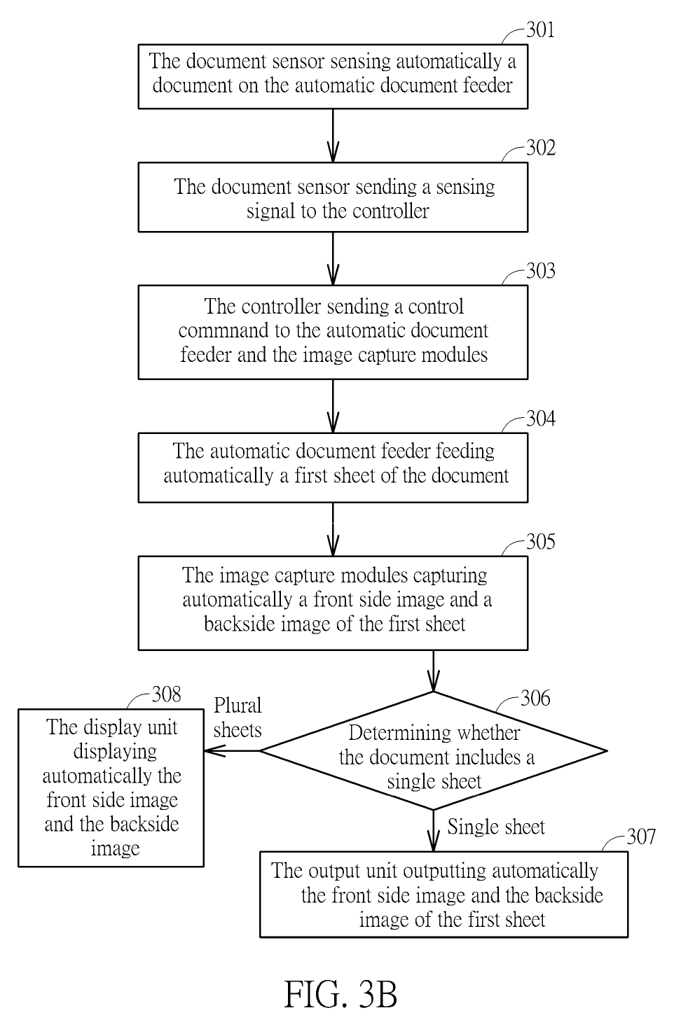

FIG. 3A is a schematic diagram of an intelligent image reproducing apparatus according to a third embodiment of the invention. Please refer to FIG. 3A. Besides the image processing unit 42, the controller 40 further includes a sheet count determining unit 44 for determining whether the document includes a single sheet or a plurality of sheets. The sheet count determining unit 44 may be disposed in the automatic document feeder 10 and connected electrically to the controller 40. The sheet count determining unit 44 may be, for example, an ultrasonic sheet sensor to determine the number of sheets using ultrasonic waves penetrating the sheets. The sheet count determining unit 44 may also be an infrared ray sensor to check whether a sheet exists thereon and determine the scanning procedure to have single or plural sheets as the automatic document feeder 10 feeds the document.

FIG. 3B is a schematic diagram of a flow chart of an intelligent image reproducing method according to the third embodiment of the embodiment. In FIG. 3B, Step 301 to Step 305 are the same as Step 101 to Step 105 in FIG. 1C. In Step 306, the sheet count determining unit 44 determines whether the document includes a single sheet or a plurality of sheets. If the document includes a single sheet, Step 307 is performed after the image capture modules 22, 24 finish capturing the image of the first sheet S and the controller 40 then outputs automatically the front side image S1 and the backside image S2 of the first sheet S.

On the other hand, when the sheet count determining unit 44 determines that the document includes a plurality of sheets, Step 308 is performed after the image capture modules 22, 24 finish capturing the images of the first sheet S and the controller 40 controls the display unit 70 to display automatically the front side image S1 and the backside image S2 of the first sheet S for follow-up processing determination by a user using the user input interface 60.

Under this condition the digital processing machine 100 provides a ‘double-sided plural documents processing mode’ or a ‘single-sided plural documents processing mode’ for being selected by a user. When the digital processing machine 100 enters the double-sided plural documents processing mode, the controller 40 controls the automatic document feeder 10 to continuously feed each sheet of the document, and the image capturing modules 22, 24 continuously capture the front side images and the backside images of the plurality of sheets that are fed. And these front side images and backside images of the sheets are displayed on the display unit 70.

when the digital processing machine 100 enters the single-sided plural documents processing mode, the controller 40 controls the automatic document feeder 10 to feed the first sheet S and the image capturing modules 22, 24 capture the front side image S1 and the backside image S2 of the first sheet S for being selected by a user. Then, the controller 40 controls the automatic document feeder 10 to continuously feed each remaining sheet of the document, and the image capturing modules 22, 24 capture the front side images or the backside images of the plurality of remaining sheets corresponding to what is selected by the user. For example, after capturing the front side image S1 and the backside image S2 of the first sheet S, the front side image S1 and the backside image S2 are displayed on the display unit 70 for user selection. When user selects an image like the backside image S2, the controller 40 controls the image capture module 22 that corresponds to capture the front side image S1 to stop working, leaving the image capture module 24 that corresponds to capture the backside image S2 to keep capturing the backside images S2′ of the remaining sheets. Scanning efficiency is lifted and power consumption is reduced and the image capture module 22 is stopped and its life may be extended.

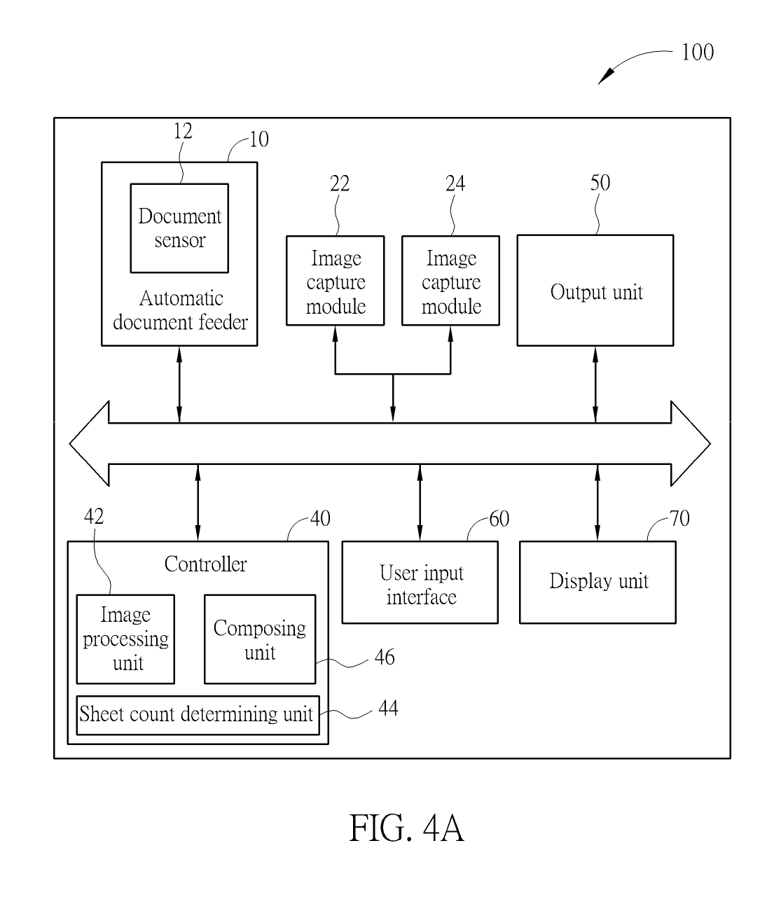

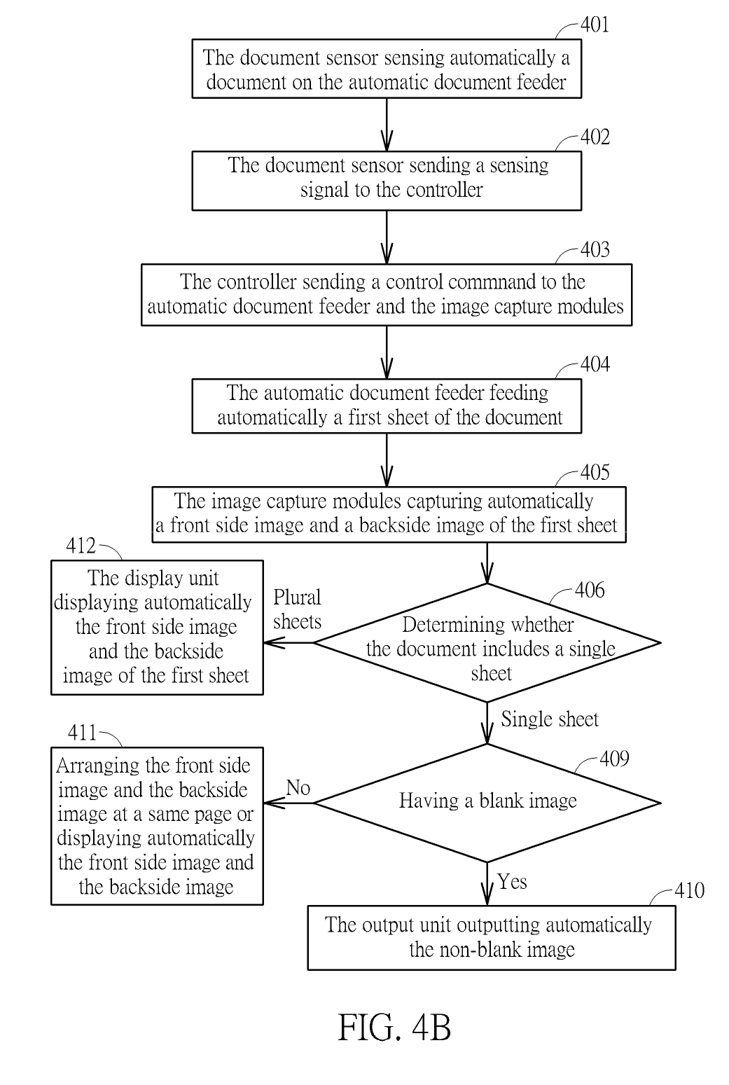

FIG. 4A is a schematic diagram of an intelligent image reproducing apparatus according to a fourth embodiment of the invention. Please refer to FIG. 4A. Similar as the third embodiment and besides determining the sheet count of the document, the fourth embodiment further determines whether the first sheet S includes blank image. The controller 40 further includes a composing unit 46 and the image processing unit 42 is utilized for determining whether the image is blank. FIG. 4B is a schematic diagram of a flow chart of an intelligent image reproducing method according to the fourth embodiment of the embodiment. In Step 406 of FIG. 4B, the sheet count determining unit 44 determines whether the document includes just a single sheet, a first sheet S. If the document includes the first sheet S only, Step 409 will be performed. In Step 409, the image processing unit 42 determines whether one of the front side image S1 and the backside image S2 of the first sheet S is a blank image and the other is a non-blank image. If yes, Step 410 is performed. In Step 410, the controller 40 controls the output unit 50 to output automatically the non-blank image of the corresponding front side image S1 or the backside image S2.

The controller 40 may further include a composing unit 46 and in Step 406, when the sheet count determining unit 44 determines the document as including simply a single sheet, the first sheet S, and the image processing unit 42 determines both of the front side image s1 and the backside image S2 of the first sheet S are non-blank images as in Step 411, the composing unit 46 then arranges the front side image S1 and the backside image S2 at a same page for following procedure. The controller 40 may also control the display unit 70 to display automatically the front side image S1 and the backside image S2 of the first sheet S for follow-up processing determination by a user using the user input interface 60.

On the other hand, in Step 406, when the sheet count determining unit 46 determines the document as including a plurality of sheets, Step 412 is then performed. The display unit 70 displays automatically the front side image S1 and the backside image S2 of the first sheet S. The ‘double-sided plural documents processing mode’ or the ‘single-sided plural documents processing mode’ as described in the third embodiment may be also provided for being selected by a user.

In summary, the intelligent image reproducing apparatus and image reproducing method according to the invention provide a ‘Drop & Take’ operation method so that the user may drop a single sheet of document to be reproduced and take the reproduced document immediately without any further operation. Additionally, the invention can determine automatically whether the document includes single or plural sheets and determine whether the document contains blank images that can be picked up and deleted automatically for the output procedure. Besides, the image processing unit further has a deskewing function that can correct automatically the skew produced when the automatic document feeder feeds the sheet through the image capture modules. The invention also provides a suitable and convenient image reproducing procedure according to the sheet count of the document and existence of blank images so as to provide a user friendly, effort free, and time saving purpose.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An intelligent image reproducing apparatus, comprising:
an automatic document feeder, comprising a document sensor for sensing a document;
two image capture modules, disposed opposite each other for scanning a front side image and a backside image of each single sheet of the document; and
a controller, connected electrically to the automatic document feeder, the image capture modules, and the document sensor;
wherein when the document sensor senses the document, the automatic document feeder automatically feeds a first sheet of the document, and the image capture modules capture the front side image and the backside image of the first sheet automatically.

2. The intelligent image reproducing apparatus of claim 1, wherein the controller comprises an image processing unit adapted for determining whether an image is a blank image.

3. The intelligent image reproducing apparatus of claim 2, further comprising an output unit connected electrically to the controller for receiving and outputting images of the document.

4. The intelligent image reproducing apparatus of claim 3, wherein when the image processing unit determines one of the front side image and the backside image of the first sheet is a blank image and the other is a non-blank image, the controller controls the output unit to output automatically the non-blank image.

5. The intelligent image reproducing apparatus of claim 2, further comprising a display unit connected electrically to the controller for receiving and displaying the images of the document.

6. The intelligent image reproducing apparatus of claim 5, wherein when the image processing unit determines both of the front side image and the backside image of the first sheet are non-blank images, the controller controls the display unit to display automatically the front side image and the backside image of the first sheet for follow-up processing determination by a user.

7. The intelligent image reproducing apparatus of claim 6, further comprising a user input interface connected electrically to the controller for receiving a command inputted by a user to determine the way of processing and outputting an image, wherein the user input interface and the display unit is integrated as a touch panel.

8. The intelligent image reproducing apparatus of claim 1, further comprising an output unit connected electrically to the controller for receiving and outputting images of the document, wherein the controller comprises a sheet count determining unit for determining whether the document includes a single sheet or a plurality of sheets.

9. The intelligent image reproducing apparatus of claim 8, wherein when the sheet count determining unit determines the document as including a single sheet, the controller controls the output unit to output automatically the images of the first sheet when the image capture modules finish capturing the images of the first sheet.

10. The intelligent image reproducing apparatus of claim 8, wherein the controller comprises an image processing unit adapted for determining whether an image is a blank image.

11. The intelligent image reproducing apparatus of claim 10, wherein when the sheet count determining unit determines the document as including a single sheet and the image processing unit determines one of the front side image and the backside image of the first sheet is a blank image and the other is a non-blank image, the controller controls the output unit to output automatically the non-blank image.

12. The intelligent image reproducing apparatus of claim 10, wherein the controller comprises a composing unit, and when the sheet count determining unit determines the document as including a single sheet and the image processing unit determines both of the front side image and the backside image of the first sheet are non-blank images, the composing unit arranges the front side image and the backside image at a same page for following procedure.

13. The intelligent image reproducing apparatus of claim 10, further comprising a display unit connected electrically to the controller for receiving and displaying the images of the document.

14. The intelligent image reproducing apparatus of claim 13, wherein when the sheet count determining unit determines the document as including a single sheet and when the image processing unit determines both of the front side image and the backside image of the first sheet are non-blank images, the controller controls the display unit to display automatically the front side image and the backside image of the first sheet for follow-up processing determination by a user.

15. The intelligent image reproducing apparatus of claim 14, further comprising a user input interface connected electrically to the controller for receiving a command inputted by a user to determine the way of processing and outputting an image, wherein the user input interface and the display unit is integrated as a touch panel.

16. The intelligent image reproducing apparatus of claim 8, further comprising a display unit connected electrically to the controller for receiving and displaying the images of the document.

17. The intelligent image reproducing apparatus of claim 16, wherein when the sheet count determining unit determines the document as including a plurality of sheets and after the image capture modules finish capturing the images of the first sheet, the controller controls the display unit to display automatically the front side image and the backside image of the first sheet for follow-up processing determination by a user.

18. The intelligent image reproducing apparatus of claim 17, further comprising a user input interface connected electrically to the controller for receiving a command inputted by a user to determine the way of processing and outputting an image, wherein the user input interface and the display unit is integrated as a touch panel.

19. The intelligent image reproducing apparatus of claim 1, further comprising a double-sided plural documents processing mode for being selected by a user, wherein when the intelligent image reproducing apparatus enters the double-sided plural documents processing mode, the controller controls the automatic document feeder to continuously feed each sheet of the document, and the image capturing modules continuously capture the front side images and the backside images of the plurality of sheets being fed.

20. The intelligent image reproducing apparatus of claim 1, further comprising a single-sided plural documents processing mode for being selected by a user, wherein when the intelligent image reproducing apparatus enters the single-sided plural documents processing mode, the controller controls the automatic document feeder to feed the first sheet and the image capturing modules capture the front side image and the backside image of the first sheet for being selected by a user; the controller controls the automatic document feeder to continuously feed each remaining sheet of the document, and the image capturing modules capture the front side images or the backside images of the plurality of remaining sheets corresponding to what is selected by the user.

21. The intelligent image reproducing apparatus of claim 3, wherein the output unit comprises a printer.

22. The intelligent image reproducing apparatus of claim 1, further comprising an output unit connected electrically to the controller for receiving and outputting the images of the document, wherein the output unit comprises an external storage device transmission port.

23. The intelligent image reproducing apparatus of claim 1, further comprising an output unit connected electrically to the controller for receiving and outputting the images of the document, the output unit comprising a network transmission port.

24. An intelligent image reproducing method operated by electronic system for a digital processing machine, comprising following steps:
a. automatically sensing a document on an automatic document feeder;
b. automatically feeding a first sheet of the document;
c. automatically capturing a front side image and a backside image of the first sheet.

25. The image reproducing method of claim 24, further comprising step after capturing the images:
d. determining whether one of the front side image and the backside image of the first sheet is a blank image.

26. The image reproducing method of claim 25, further comprising step after determining the blank image:
e. an output unit automatically outputting the non-blank image if one of the front side image and the backside image of the first sheet is a blank image and the other is a non-blank image.

27. The image reproducing method of claim 25, further comprising step after determining the blank image:
e. displaying the front side image and the backside image of the first sheet on a display unit if both of the front side image and the backside image of the first sheet are non-blank images.

28. The image reproducing method of claim 24, further comprising step after capturing the images:
d. determining the document as including a single sheet or a plurality of sheets.

29. The image reproducing method of claim 28, further comprising step after determining the sheet count:
e. when the document includes a single sheet, automatically outputting the first sheet after automatically capturing a front side image and a backside image of the first sheet.

30. The image reproducing method of claim 28, further comprising step after determining the sheet count:
e. when the document includes a plurality of sheets, automatically feeding one by one the plurality of sheets and capturing the front side images and the backside images of the plurality of sheets being fed.

31. The image reproducing method of claim 30, further comprising step after feeding one by one the plurality of sheets: displaying the front side images and the backside images of the plurality of sheets on a display unit.
